(19) United States
(12) Patent Application Publication
(10) Pub. No.: US 2015/0285132 A1
(43) Pub. Date: Oct. 8, 2015

(54) ACTUATOR ROD SEALING SYSTEM

(71) Applicant: BorgWarner Inc., Auburn Hills, MI (US)

(72) Inventors: Jason W. Chekansky, Asheville, NC (US); Timothy House, Hendersonville, NC (US); Brian Edward Handlon, Horse Shoe, NC (US); Daniel N. Ward, Asheville, NC (US)

(21) Appl. No.: 14/402,698

(22) PCT Filed: May 16, 2013
(86) PCT No.: PCT/US13/41282

§ 371 Date: Nov. 21, 2014

Related U.S. Application Data
(60) Provisional application No. 61/653,465, filed on May 31, 2012.

(51) Int. Cl. F02B 37/18; F04D 29/08

(52) U.S. Cl. CPC F02B 37/186; F04D 29/083

(57) ABSTRACT

Turbochargers use actuators to control wastegate valve or VTG vane position to control turbine wheel power. Components of such actuators are susceptible to damage when exposed to foreign liquids, solids and debris. To prevent such ingress, boot seals at the actuator shaft can provide a tortuous path for air aspiration and expulsion from the volume inside the actuator boot is provided at one or more interfaces in the actuator system. Such a path can also prevent ingress of undesired liquids, solid and debris, which can affect actuator performance material. In one arrangement, a tortuous pathway is provided between a boot seal holder and another actuator component. In another arrangement, a tortuous pathway is provided between the actuator shaft and an end portion of a boot seal.

### FIELD OF THE INVENTION

Embodiments relate in general to turbochargers and, more particularly, to actuator systems in a turbocharger.

### BACKGROUND OF THE INVENTION

Turbochargers are a type of forced induction system. They deliver air, at greater density than would be possible in the normally aspirated configuration, to the engine intake, allowing more fuel to be combusted, thus boosting the engine's horsepower without significantly increasing engine weight. A smaller turbocharged engine, replacing a normally aspirated engine of a larger physical size, will reduce the mass and can reduce the aerodynamic frontal area of the vehicle.

Referring to FIG. 1, a turbocharger (10) uses the exhaust flow from the engine exhaust manifold to drive a turbine wheel (12), which is located in a turbine housing (14). Once the exhaust gas has passed through the turbine wheel (12) and the turbine wheel (12) has extracted energy from the exhaust gas, the spent exhaust gas exits the turbine housing (14) through an exducer and is ducted to the vehicle downpipe and usually to after-treatment devices such as catalytic converters, particulate traps, and NOₓ traps.

There are many instances in which an actuator system may be used in a turbocharger. For instance, in a wastegated turbocharger, the turbine volute is fluidly connected to the turbine exducer by a bypass duct. Flow through the bypass duct is controlled by a wastegate valve. In a bypass mode, exhaust gases flow through the bypass duct so as to bypass the turbine wheel (12), thus not powering the turbine wheel (12). To operate the wastegate, an actuating or control force must be transmitted from outside the turbine housing (14) to the wastegate valve inside the turbine housing (14). To that end, a wastegate pivot shaft (not shown) extends through the turbine housing (14) and rotates about its axis (16) when driven by an actuator (18).

Outside the turbine housing (14), an actuator (18) is connected to a wastegate arm (20) via an actuator shaft (22) and linkage (23). The actuator (18) is mounted to a mounting flange (24) of an actuator bracket (26). The wastegate arm (20) is connected to the wastegate pivot shaft (not shown). Inside the turbine housing (14), the wastegate pivot shaft is connected to a wastegate valve (not shown). Actuating force from the actuator (18) is translated into rotation of the wastegate pivot shaft, moving the wastegate valve inside the turbine housing (14) to bypass exhaust flow to the turbine wheel (14).

Pneumatic actuators operate by air pressure (which can be positive or negative, typically depending up on the source of the pressure) distending a diaphragm being resisted by a spring of known rate, often accompanied by atmospheric pressure on the spring side of the diaphragm. The motion of the diaphragm (28) is transferred to the extension of a shaft (22), which then translates to rotation of a wastegate arm (20) attached to a wastegate pivot shaft (not shown), which rotates, thereby opening or closing the wastegate valve (not shown). A wastegate spring (38) resists the pressure exerted on the diaphragm (28) and is used to return the shaft (22) to its resting position (with the wastegate valve in the closed position).

As commanded by the engine control unit (ECU), air pressure is delivered to the actuator (18) through the air fitting (40) to fill the volume between the actuator (18) and the upper canister shell (34). The pressure of the incoming air to the actuator (18) forces the diaphragm (28) away from the at-rest position, resisted by the force exerted by a spring (38). The inflation of the volume behind the diaphragm (28) forces the diaphragm (28) to compress the spring (38) via displacement of a piston (42) to which the actuator shaft (22) is attached, as described above.

The actuator (18) is typically located close to the turbine housing (14). Turbine housings (14) experience great temperature flux. The outside of the turbine housing (14) is exposed to ambient air temperature while the volute surfaces are exposed to exhaust gases at temperatures ranging from 740° Celsius to 1050° Celsius, depending on the fuel used in the engine. It is essential that the actuator (18), via the translated motions described above, be able to control the wastegate to thereby control flow to the turbine wheel (12) in an accurate, repeatable, non jamming manner.

However, the proximity of the wastegate actuator (18) to the turbine housing (14) has multiple effects. Heat can conductively travel up the actuator shaft (22) to the actuator diaphragm (28). Heat from the turbine housing (14), to which most actuators are mounted, can be radiatively transferred not only to the actuator shaft (22), and thence to the actuator diaphragm (28), but also to the actuator canister components such as: the base ring (30); the lower canister (32); and the upper canister (34). The latter components are sometimes protected from radiative heat transfer by incorporating an actuator heat shield (36) surrounding the affected components. An annular gap (69) exists between the outside diameter of the holder (65) and the inside diameter of the actuator heat shield (43).

Actuator systems are also used in other types of turbochargers. For instance, in variable geometry turbochargers (VTG) an actuator is used to control the angle of a vane set within the turbine housing, and that, in turn, controls the turbine power. In regulated two stage turbocharger (R2S) configurations, a valve or flap driven by an actuator is used to: control turbine flow and exhaust back pressure; to control EGR flow; to apply a large or a small turbo to suit engine requirements such as transient performance or steady state performance; and to control valves that are used to bypass compressor outflows to control the swallowing capacity of large and small compressor stages in the same system.

Turbochargers are located in the engine compartment of a vehicle, outside the engine block and often (for example on in-line straight four or six cylinder engines) are located adjacent to the wheels. Some turbochargers, for example on twin turbo V-type engines, are located very low in the engine compartment to keep the engine's center of gravity as low as possible and to make the exhaust manifolds to the turbochargers as short as possible. As such, these turbochargers are subjected to undesirable substances, including road fluids (e.g., water and mud) materials (e.g., grit and anti-ice chemicals) and debris.

If any of such undesired substances enters the area in which the diaphragm (28) contacts either the piston (42) or the outer canister shells (32, 34) of the actuator (18), then the material of the diaphragm (28) will fret, which will ultimately lead to failure of the diaphragm (28) and, thus, the actuator (18). Actuators (18) can be equipped with a bellows-type boot seal (44) which attaches on the actuator shaft (22) on one end and to a holder (46) on the actuator (18) end thereof. The plurality of convolutes in the bellows of the boot seal (44) ensures that any translation (extension or retraction) of the actuator shaft (18) results only in relatively linear extension or contraction of the boot seal (44) rather than the boot seal (44) collapsing and touching the shaft (22). This extension or contraction of the boot seal (44) is accompanied by an increase or reduction of the volume of air in the boot seal (44), and this change of volume of air must be aspirated externally to the boot seal (44) to resist blowing up or collapsing of the boot seal (44). Typically the boot seals (44) are allowed to aspirate, through a hole pieced in one of the convolutes, through an aperture between the boot seal (44) and the shaft (22), or through an aperture between the boot seal (44) and the mounting for the boot seal (44). Some designs allow for a hole in the lower metal canister (32) or between external elements of the actuator canister. Any of these methods can allow ingress of unwanted fluids and/or debris which can be harmful to the diaphragm (28), which can affect the performance of the actuator (18).

When a turbocharged engine calls for a change in a performance aspect of a wastegated turbocharger, VTG or other turbocharger, an actuator changes position (i.e., an actuator shaft moves). As a result, there is a change in the volume of air under the actuator diaphragm in the case of pneumatic actuators or the volume of air in an actuator boot. To satisfy the need for air aspiration to maintain close to atmospheric pressure in both volume under the actuator diaphragm and the bellows as the length of the actuator shaft changes, the passage of air must be permitted, but not the passage of unwanted fluids, matter and/or debris which can be harmful to the performance of the actuator. Thus, there is a need for a sealing system that can minimize such concerns.

### SUMMARY OF THE INVENTION

Embodiments herein are directed to a sealing system for an actuator system in a turbocharger. Arrangements herein can allow the ingress and exit of air. Arrangements herein can also inhibit the ingress of undesired substances, matter and debris, which can affect the performance of and shorten the projected life of an actuator. Such objectives can be achieved by providing one or more tortuous flow paths in various interfaces between various components of the actuator system. The tortuous flow paths can have any suitable form.

### BRIEF DESCRIPTION OF THE DRAWINGS

The present invention is illustrated by way of example and not limitation in the accompanying drawings in which like reference numbers indicate similar parts, and in which:

FIG. 1 is a view of a typical wastegated turbocharger;

FIG. 2 is a cross-sectional view of a typical actuator;

FIG. 3 is a cross-sectional view of sealing system for an interface configured according to embodiments herein, wherein the interface is formed between a boot holder and neighboring actuator components;

FIG. 4 is a cross-sectional view of a boot holder configured with a first tortuous flow path configuration according to embodiments herein;

FIG. 5 is a cross-sectional view of a boot holder configured with a second tortuous flow path configuration according to embodiments herein;

FIG. 6 is a cross-sectional view of an embodiment of a sealing system for an interface configured according to embodiments herein, wherein the interface is formed between an actuator rod and a boot seal;

FIG. 7 is a cross-sectional view of a second embodiment of a sealing system for an interface configured according to embodiments herein, wherein the interface is formed between an actuator rod and a boot seal; and

FIG. 8 is a cross-sectional view of a third embodiment of a sealing system for an interface configured according to embodiments herein, wherein the interface is formed between an actuator rod and a boot seal.

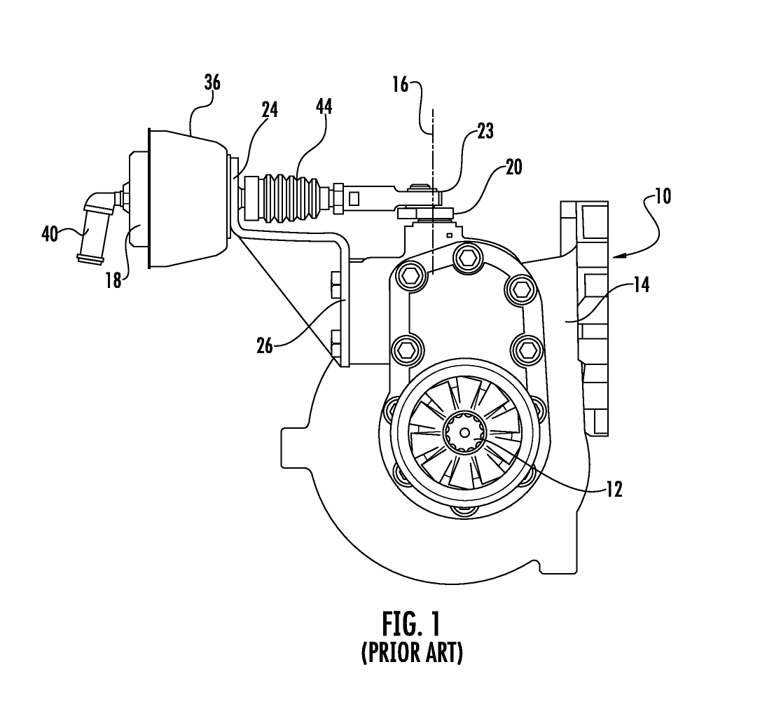

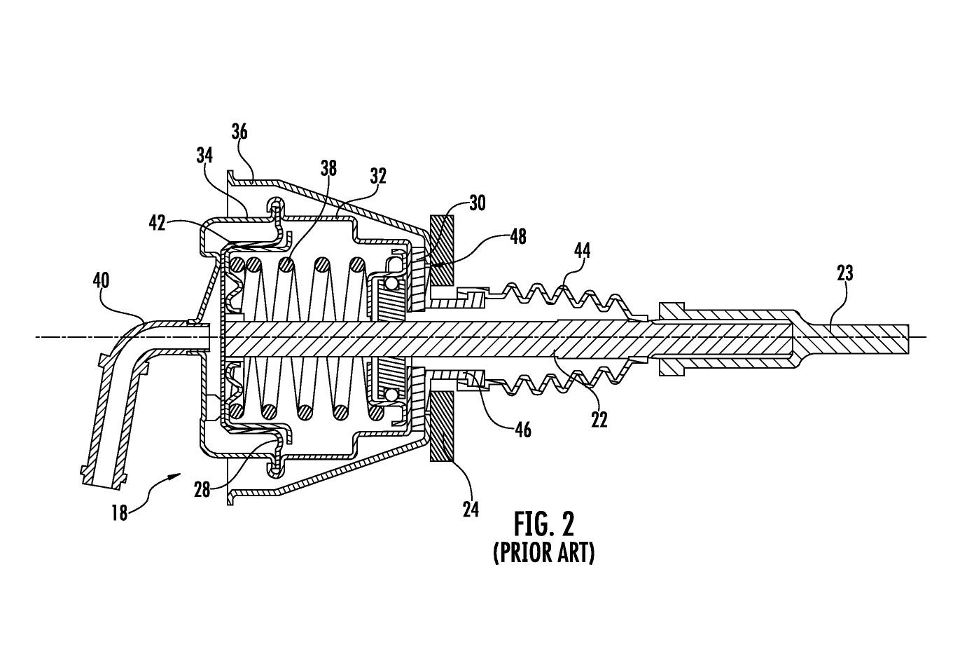

### DETAILED DESCRIPTION OF THE INVENTION

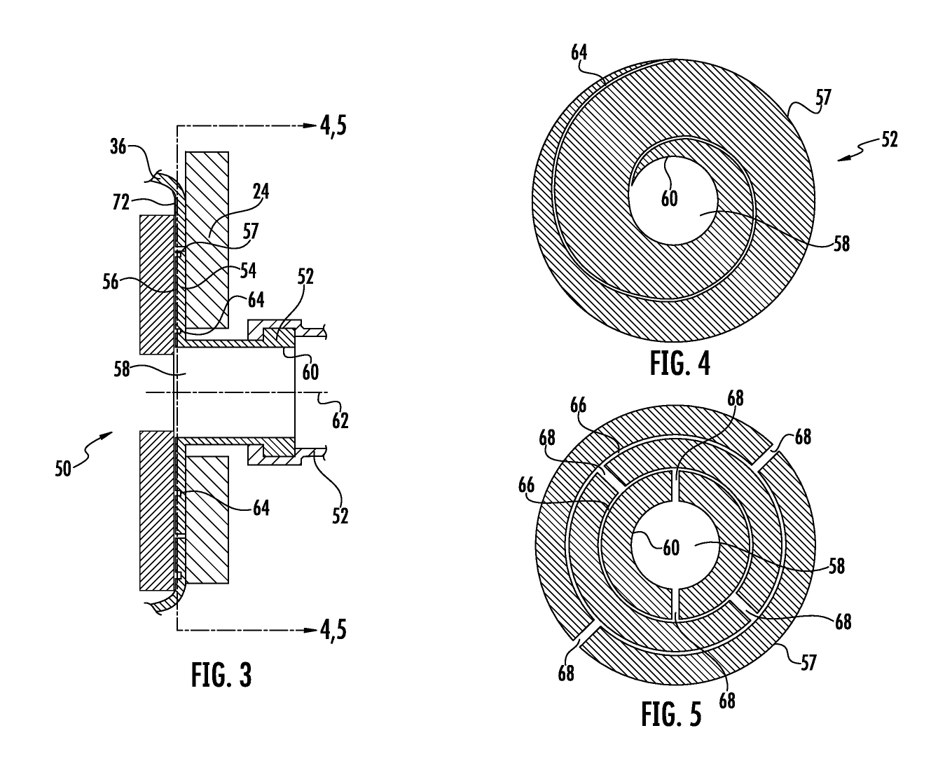

Arrangements described herein relate to sealing systems for an actuator system in a turbocharger. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Arrangements are shown in FIGS. 3-8, but the embodiments are not limited to the illustrated structure or application.

Referring to FIGS. 3-5, examples of sealing systems for an interface (50) formed between an actuator boot holder (52) and neighboring actuator components are shown. However, it will be understood that embodiments are not limited to these examples or any particular arrangement.

The actuator boot holder (52) can include a flange portion (54). The flange portion (54) can have an actuator facing surface (56) and an outer peripheral surface (57). The holder (52) has a center bore (58) with an inner peripheral surface (60). The holder has an associated longitudinal axis (62). The holder (52) and the heat shield (36) can be sandwiched between two components, such as, for example, the mounting flange (24) of the actuator bracket (26) and the base ring (30) of the actuator (18). According to embodiments herein, a tortuous flow path can be provided at the interface (50). As used herein, “tortuous” means non-straight and can include a plurality of twists, turns, curves, bends, windings, other non-straight features and/or combinations thereof.

In one embodiment, the tortuous flow path can be defined at least in part by the flange portion (54) of the holder (52). The tortuous flow path can have any suitable configuration. FIG. 4 shows an embodiment in which the flow path can be defined by one or more flow channels (64) formed on the actuator facing surface (56) of the flange portion (54) of the holder (52). The flow channel (64) can have any suitable configuration. As an example, the flow channel (64) can extend in a generally helical arrangement, as is shown in FIG. 4. The flow channel (64) can extend from the bore (58) to the outer peripheral surface (57) of the flange portion (54).

The cross-sectional area of the flow channel (64) can be substantially constant, or it can vary in one or more places along its length. The flow channel (64) can have any suitable size and shape. While only a single flow channel (64) is shown in FIG. 4, it will be understood that additional flow channels can be provided. Such additional flow channels may or may not have a generally helical arrangement. Further, such additional flow channels may or may not cross each other.

FIG. 5 shows another embodiment in which the tortuous flow path can be defined at least in part by one or more generally circumferential channels (66). The generally circumferential flow channels (66) can be formed on the actuator facing surface (56) of the flange portion (54) of the holder (52). “Generally circumferential” means that the channels (66) extend in a generally round, circular, oval, curving or arc-like manner about an axis (e.g., axis (62)). The circumferential flow channels (66) can be substantially concentric with the axis (62) of the boot holder (52), or the circumferential flow channels (66) may not be concentric with the axis (62) of the boot holder (52).

When a plurality of circumferential flow channels (66) is provided, the flow channels (66) can be distributed in any suitable manner. For instance, the circumferential flow channels (66) can be substantially equally spaced. Alternatively, one or more of the circumferential flow channels (66) can be non-equally spaced. In some instances, at least one of the circumferential flow channels (66) can cross one or more of the other circumferential flow channels (66) to allow fluid communication therebetween. There can be any suitable quantity of circumferential flow channels (66).

The tortuous flow path can also include one or more generally radial flow channels (68). “Generally radial” means that the flow channels (68) extend in any general direction between the inner peripheral surface (60) and the outer peripheral surface (57) of the flange portion (54), including extending substantially radially to the axis (62) and non-radially to the axis (62). The generally radial flow channels (68) can allow fluid communication between the circumferential flow channels (66). The radial flow channels (68) can also allow fluid communication between one or more of the circumferential flow channels (66) and the bore (58) and/or the outer peripheral surface (57) or the environment. The radial flow channels (68) can be arranged so as to be offset from each other, as is shown in FIG. 5. In such case, a radial flow channel (68) is not aligned with another radial flow channel (68). Such offset can be provided in any suitable manner.

Likewise, the radial flow channels (68) can be substantially equally spaced. Alternatively, one or more of the radial flow channels (68) can be non-equally spaced. There can be any suitable quantity of radial flow channels (68).

The cross-sectional area of the flow channels (66, 68) can be substantially constant. Alternatively, the cross-sectional area of one or more of the flow channels (66, 68) can vary in one or more places along its length. The flow channels (66, 68) can have any suitable size and shape. The circumferential flow channels (66) can be substantially identical to each other, or at least one of the circumferential flow channels (66) can differ from the other circumferential flow channels (66) in one or more respects. Likewise, the radial flow channels (68) can be substantially identical to each other, or at least one of the radial flow channels (68) can differ from the other radial flow channels (68) in one or more respects.

The flow channels (64, 66, 68) can be formed in any suitable manner. For instance, the flow channels (64, 66, 68) can be defined by grooves formed in the flange portion (54). Such grooves can be formed by, for example, machining, laser etching, coining, and injection molding. Alternatively, the flow channels (64, 66, 68) can be defined by elements projecting from the actuator-facing surface (56) of the flange portion (54). Such elements can be formed with the holder (52) or they can be formed separately and attached to the flange portion (54) in any suitable manner.

When the holder (52) is sandwiched between other actuator components, such as the flange (24) of the actuator bracket (26) and the base ring (30) of the actuator (18), the above-described channels (64, 66, 68) can cooperatively define flow passageways (70) with another actuator components that is adjacent to the actuator facing surface (56) of the holder (52). “Adjacent” includes direct physical contact and/or slight spacing therebetween. There can be an annular gap (48) between the outer peripheral surface (57) of the holder (52) and the inner peripheral surface of the actuator heat shield (36).

It should be noted that, as an alternative to or in addition to the above arrangements, the flow passageways can be defined at least in part by other components of the interface (50). For instance, one or more flow channels (70) can be formed in the actuator facing face (72) of the actuator heat shield (36). The channel (72) can have any suitable configuration, including any of those mentioned above. Further, the flow channels can be provided in other parts forming the interface (50), such as the base ring (30) of the actuator, the heat shield (36), the flange (24) or even the actuator bracket (26) as long as a hole was provided in the holder (52) to provide aspiration from inside the bore (58) of the holder (52) to the tortuous flow passage.

As a result of the embodiments described in connection with FIGS. 3-5, the changing volume (as the actuator rod extends or retracts) inside the actuator boot (44) can pressure equalize through the flow channels/passageways while the tortuous path can minimize the infiltration of undesired and potentially harmful liquids, solids and debris into the actuator (18) and/or boot (44), which would adversely affect the performance and life of the actuator (18).

Embodiments herein can be used in connection with other interfaces in an actuator system in a turbocharger. FIGS. 6-8 show examples of sealing systems for an interface (80) formed between an actuator rod (82) and a boot seal (84). However, it will be understood that embodiments are not limited to these examples or any particular arrangement.

Referring to FIG. 6, the boot seal (84) can include a bellows portion (86) and an end portion (88). The end portion (88) can be generally tubular and can have an inner peripheral surface (90). The actuator rod (82) can be received in the boot seal (84) such that the inner peripheral surface (90) of the end portion (88) substantially sealingly engages the outer peripheral surface (92) of the actuator rod (82). According to embodiments herein, the inner peripheral surface (90) of the end portion (88) can include a tortuous flow path formed therein. In one embodiment, a groove (94) can be formed in the inner peripheral surface (90) of the end portion (88). The groove (94) can extend along at least a portion of the length of the end portion (88) in any suitable tortuous manner. The groove (94) can extend to the end (96) of the boot seal (84). The groove (94) can be formed in any suitable manner, such as by machining or casting.

The groove (94) can have any suitable tortuous configuration. In one embodiment, the groove (94) can be formed in a helical configuration, as is shown in FIG. 6. However, embodiments are not limited to a helical configuration. In some instances, the groove (94) can have a zig-zag like configuration to make passage of undesired liquids and solids more difficult.

The cross-sectional area of the groove (94) can be substantially constant, or it can vary in one or more places along its length. The groove (94) can have any suitable size and shape. Further, the groove (94) can be configured to have a plurality of portions that extend generally in the direction of the axis of the boot seal (84) with turns near the ends of the end portion to create a cross-flow like arrangement. While only a single continuous groove (94) is shown in FIG. 6, it will be understood that additional grooves can be provided. Such additional grooves may or may not have a generally helical arrangement. Further, such additional grooves may or may not cross the groove (94).

When the boot seal (84) is provided about the outer peripheral surface (92) of the actuator rod (82), a passageway (97) can be defined between the groove (94) and the inner peripheral surface (90) of the end portion (88). The groove (94) and/or passageway (97) can have a long length compared to its cross-sectional area. Thus, the path for undesired liquids, solids or debris becomes long tortuous, thereby making it difficult for such substances to reach critical components of the actuator system. However, it will be appreciated that air transfer is allowed in either direction along the groove (94) and/or passageway (97).

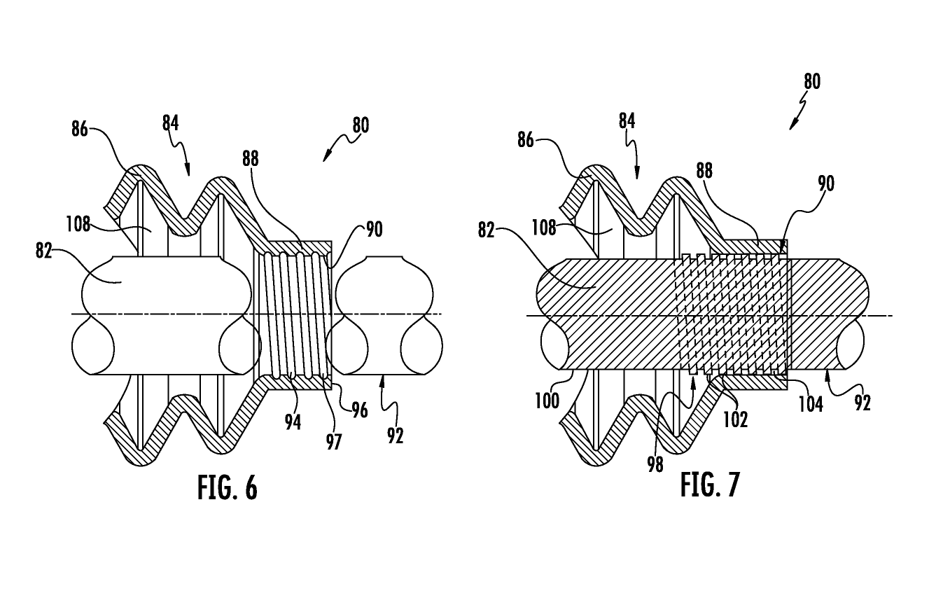

Referring to FIG. 7, another example of a sealing system for the interface (80) formed between an actuator rod (82) and a boot seal (84) is shown. In this arrangement, the actuator rod (82) can be configured with a tortuous contour to form a tortuous path along the interface (80). In one embodiment, the outer peripheral surface (92) of the actuator rod (82) can be configured with external threads (98). The threads (98) can extend in a substantially helical manner along at least a portion of the length of the actuator rod (82), as is shown in FIG. 7. However, embodiments are not limited to a helical configuration. The threads (98) can extend substantially continuously along the actuator rod (82), or they threads (98) can be formed by a plurality of discontinuous elements. The threads (98) can be formed in any suitable manner, such as by machining.

The threads (98) can be configured in any suitable manner. For instance, the threads (98) can be defined by grooves formed in the outer peripheral surface (92) of the actuator rod (82). In such case, the diameter of the threaded portion can be substantially equal to the diameter of a non-threaded portion (100) of the actuator rod (82). Alternatively, the threads (98) can be defined by one or more elements (102) that protrude outward from the outer peripheral surface (92) of the actuator rod (82). In such case, the diameter of the threaded portion can be greater than the diameter of the non-threaded portion (100) of the actuator rod (82). The inner peripheral surface (90) of the end portion (88) can be substantially free of grooves. The diameter of the inner peripheral surface (90) of the end portion (88) can be slightly smaller than the diameter of the threads (98) to facilitate engagement between the actuator rod (82) and the boot seal (84).

When the boot seal (84) is provided about the outer peripheral surface (92) of the actuator rod (82), a passageway (104) can be defined between the threads (98) and the inner peripheral surface (90) of the end portion (88).

The cross-sectional area of the passageway (104) can be substantially constant, or it can vary in one or more places along its length. The passageway (104) can have any suitable size and shape. While only a single continuous passageway (104) is shown in FIG. 6, it will be understood that additional passageways can be provided. Such additional passageway may or may not have a generally helical arrangement. Further, such additional passageway may or may not cross the passageway (104).

The passageway (104) has a long length compared to its cross-sectional area. Thus, the path for undesired liquids, solids or debris becomes long tortuous, thereby making it difficult for such substances to reach critical components of the actuator system. However, it will be appreciated that air transfer is allowed in either direction along the passageway (104).

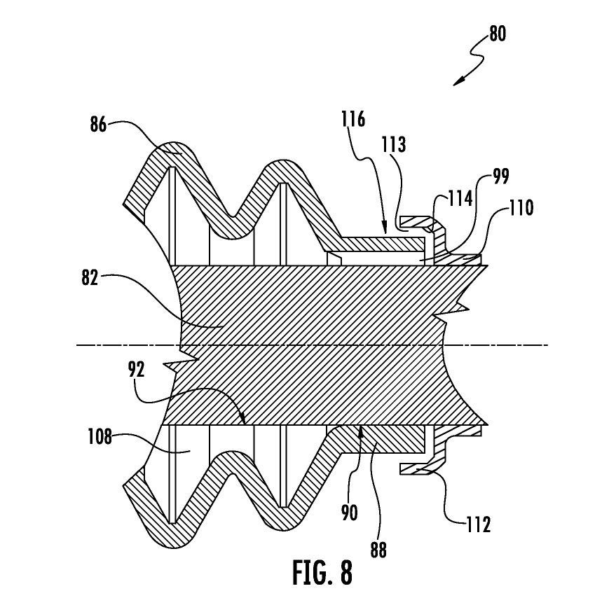

Referring to FIG. 8, another example of a sealing system for the interface (80) formed between an actuator rod (82) and a boot seal (84) is shown. In this arrangement, a cover element (110) can be provided. A tortuous path may or may not be provided at the interface between the end portion (88) of the boot seal (84) and the actuator rod (82), such as any of those described above.

The cover element (110) can have any suitable form. For instance, the cover element (110) can include a bore sized to substantially matingly engage the outer peripheral surface (92) of the actuator rod (82). The cover element (110) can also include a flange portion (112) contoured in a generally concave manner. The cover element (110) can be made of plastic or other suitable material. The cover element (110) can be rigid, semi-rigid or flexible. The cover element (110) can be formed in any suitable manner, such as by injection molding.

The cover element (110) can shroud at least a portion of the interface (80) between the actuator rod (82) and the end portion (88) of the boot seal (84). Thus, at least a portion of the interface (80) can be received within the flange portion (112) of the cover element (110).

It will be appreciated that a tortuous flow pathway (113) can be created between an actuator facing surface (114) of cover element (110) and an outer peripheral surface (116) of the end portion (88) as well as the end (96) of the boot seal (84). Such a tortuous pathway (113) can prevent the ingestion of undesired liquids, solids and debris while allowing passage of air into and out of the volume (108). The cover element (110) can also act like an umbrella over the interface (80).

In some embodiments, one or more flow pathways can be provided to allow fluid communication between the end portion (88) of the boot seal (84) with the volume (108) inside the bellows portion (86) of the actuator boot (84). To that end, one or more flow channels can be formed in the end portion (88) of the boot seal (84) and/or in the outer peripheral surface (92) of the actuator rod (82). As an example, a single flow channel (99) can be formed in the boot seal (84), as is shown in FIG. 8. The flow channel (99) can have any suitable size, shape and/or configuration. In one embodiment, the flow channel (99) can be substantially straight. In another embodiment, at least a portion of the flow channel (99) can be non-straight. The flow channel (99) can open to the inner peripheral surface (90) of the end portion (88) of the boot seal (84). However, in other instances, the flow channel (90) may not open to the inner peripheral surface (90).

While FIG. 8 shows a single flow channel (99), it will be understood that embodiments are not limited to such an arrangement. Indeed, in some instances, there can be a plurality of flow channels. In such case, the flow channels can be substantially identical to each other, or at least one of the flow channels can be different from the other flow channels in one or more respects. Further, the plurality of flow channels can be substantially equally spaced, or the plurality of flow channels can be unequally spaced. It will be appreciated that combinations of any of the above described embodiments in connection with FIGS. 3-8 can be implemented. Further, it will be understood that embodiments herein can be used in connection with any type of actuator system, including pneumatic, electronic, ding hydraulic and vacuum actuators. In addition, as noted above, arrangements herein can be used in connection with other interfaces in the actuator system, and embodiments are not limited to the above arrangements. As an example, the embodiments shown in FIGS. 3-8 can also be applied to the opposite end of the boot seal (that is, at the interface between the boot seal and the holder).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

Aspects described herein can be embodied in other forms and combinations without departing from the spirit or essential attributes thereof. Thus, it will of course be understood that embodiments are not limited to the specific details described herein, which are given by way of example only, and that various modifications and alterations are possible within the scope of the following claims.

1. A sealing system for an interface (50) for a turbocharger actuator system comprising:
an actuator boot seal (44);
an actuator seal holder (52) operatively connected to an end of the actuator boot seal (44), the seal holder (52) having a center bore (58) and a flange portion (54), the flange portion (54) including an actuator facing surface (56);
a component (30) substantially adjacent to the actuator facing surface (56) of the seal holder (52); and
a tortuous passageway defined between the actuator facing surface (56) of the flange portion (54) and the component (30).

2. The sealing system of claim 1, wherein the passageway is at least partially defined by a flow channel (64, 66, 68) provided on the actuator facing surface (56) of the flange portion (54).

3. The sealing system of claim 2, wherein the flow channel (64) extends generally helically from the center bore (58) of the seal holder (52) to the outer peripheral surface (57) of the flange portion (54).

4. The sealing system of claim 2, wherein the flow channel includes a plurality of substantially circumferential flow channels (66) interconnected by a plurality of substantially radial flow channels (68).

5. The sealing system of claim 4, wherein at least one of the substantially radial flow channels (68) is in fluid communication with the center bore (58), and at least one of the substantially radial flow channels (68) is in fluid communication with the outer peripheral surface (57) of the flange portion (54).

6. The sealing system of claim 5, wherein the substantially radial flow channels (68) that connect one pair of circumferential flow channels (66) are offset from the radial flow channels (68) that connect another pair of circumferential flow channels (66).

7. The sealing system of claim 1, further including a heat shield (36), wherein a tortuous passageway (70) is defined between an actuator facing surface (72) of the heat shield (36) and the component (30).

8. A sealing system for an interface (80) for a turbocharger actuator system comprising:
a boot seal (84) including an end portion (88), the end portion (88) being generally tubular and having an inner peripheral surface (90);
an actuator rod (82) having an outer peripheral surface (92), the actuator rod (82) being at least partially received in the boot seal (84) such that the inner peripheral surface (90) of the end portion (88) substantially sealingly engages the outer peripheral surface (92) of the actuator rod (82); and
a passageway defined between the inner peripheral surface (90) of the end portion (88) and the outer peripheral surface (92) of the actuator rod (82), the passageway (97, 104) following a tortuous path.

9. The sealing system of claim 8, wherein the passageway (97, 104) is at least partially defined by a flow channel (94) formed in the inner peripheral surface (90) of the end portion (88) of the boot seal (84).

10. The sealing system of claim 9, wherein the flow channel (94) extends generally helically along at least a portion of the length of the end portion (88) of the boot seal (84).

11. The sealing system of claim 8, wherein the passageway (97, 104) is at least partially defined by a contour of the outer peripheral surface (92) of the actuator rod (82).

12. The sealing system of claim 11, wherein the contour includes external threads (98) formed on the outer peripheral surface (92) of the actual rod (82).

13. A sealing system for an interface (80) for a turbocharger actuator system comprising:
a boot seal (84) including an end portion (88), the end portion (88) being generally tubular and having an inner peripheral surface (90);
an actuator rod (82) having an outer peripheral surface (92), the actuator rod (82) being at least partially received in the boot seal (84) such that the inner peripheral surface (90) of the end portion (88) substantially sealingly engages the outer peripheral surface (92) of the actuator rod (82) to thereby form an interface therebetween; and
a cover (110) element including a bore sized to substantially sealingly engage the outer peripheral surface (92) of the actuator rod (82), the cover element (110) further including a concave flange portion (112),
the actuator rod (82) being received in the bore of the cover element (110) such that at least a portion of the interface between the actuator rod (82) and the end portion (88) is received in the concave flange portion (112), whereby a tortuous flow pathway (113) is formed between the cover element (110) and the boot seal (84).
